(19) United States
(12) Patent Application Publication
(10) Pub. No.: US 2010/0329361 A1
(43) Pub. Date: Dec. 30, 2010

(54) APPARATUS AND METHOD FOR IN-LOOP FILTERING OF IMAGE DATA AND APPARATUS FOR ENCODING/DECODING IMAGE DATA USING THE SAME

(75) Inventors: Byeong-Doo CHOI, Siheung-si (KR); Dae-Sung CHO, Seoul (KR); Dong-Gyu SIM, Seoul (KR); Kwang-Soo JUNG, Seoul (KR)

Correspondence Address: SUGHRUE MION, PLLC, 2100 PENNSYLVANIA AVENUE, N.W., SUITE 800, WASHINGTON, DC, 20037, US

(73) Assignees: SAMSUNG ELECTRONICS CO., LTD., Suwon-si, (KR); Kwangwoon University Industry-Academic Collaboration Foundation, Seoul (KR)

(21) Appl. No.: 12/827,382

(22) Filed: Jun. 30, 2010

Related U.S. Application Data
(60) Provisional application No. 61/221,770, filed on Jun. 30, 2009.

(51) Int. Cl. H04N 7/26

(52) U.S. Cl. 375/240.29; 375/E07.193

(57) ABSTRACT

An in-loop filtering apparatus for eliminating an error of deblocking-filtered image data in an encoder of image data, the apparatus including: an in-loop filter generator which generates in-loop filters using different filter coefficients for a block boundary and a block inside of the deblocking-filtered image; an in-loop filter applier which performs selective filtering on at least one of the block boundary and the block inside using the generated in-loop filters; and an in-loop filter information generator which generates in-loop filter information including at least one of coefficients of the generated in-loop filters, information indicating an area to which in-loop filtering is applied between the block boundary and the block inside, a size of a block to which in-loop filtering is applied, and a flag indicating whether to use an in-loop filter generated for a current frame or an in-loop filter generated for a previous frame.

### CROSS-REFERENCE TO RELATED PATENT APPLICATION

This application claims the benefit of U.S. Provisional Application No. 61/221,770, filed on Jun. 30, 2009, the entire disclosure of which is hereby incorporated by reference.

### BACKGROUND

1. Field

Apparatuses and methods consistent with exemplary embodiments generally relate to an apparatus and method for video coding/decoding, and more particularly, to a video coding/decoding apparatus and method for increasing video coding efficiency through in-loop filtering after deblocking filtering is applied.

2. Description of Related Art

Related art standard technologies for video compression, such as H.261, H.263, Motion Picture Expert Group-1 (MPEG-1), MPEG-2, MPEG-4, H.264, etc., are similar in structure in that they involve motion estimation and compensation, transform coding, and entropy coding. In particular, H.264 enables more accurate prediction during motion estimation and compensation as well as subjective video quality improvement by minimizing block boundary distortion observed in images that are reconstructed using a deblocking filter as an in-loop filter, thus increasing overall coding efficiency. Despite the benefit of good performance for low-bit rate images, the deblocking filter is not suitable for high-quality images. Rather, the deblocking filter used in H.264 degrades coding performance for high-quality images.

A loop filter minimizes errors between an original image and a reconstructed image. The loop filter increases coding efficiency in high-quality images without being used together with a deblocking filter. Thus, the loop filter has recently emerged as an issue for standardization.

In a related art, one in-loop filter is created for every image slice during coding and the same in-loop filter is applied to a reconstructed image. Due to the use of one filter per slice, the characteristics of each image block are neglected.

### SUMMARY

Aspects of exemplary embodiments provide an apparatus and method for performing in-loop filtering on image data to which deblocking filtering has been applied. Moreover, aspects of exemplary embodiments provide an apparatus and method for encoding and decoding image data using the in-loop filtering apparatus and method.

According to an aspect of an exemplary embodiment, there is provided an in-loop filtering apparatus for eliminating an error of deblocking-filtered image data in an encoder that encodes image data, the in-loop filtering apparatus including: an in-loop filter generator which generates, for use in in-loop filtering, a first in-loop filter using a first filter coefficient for a block boundary of the deblocking-filtered image and a second in-loop filter using a second filter coefficient for a block inside of the deblocking-filtered image; an in-loop filter applier which performs selective filtering on at least one of the block boundary and the block inside of the image using the generated in-loop filters; and an in-loop filter information generator which generates in-loop filter information that includes at least one of coefficients of the generated in-loop filters, information indicating an area to which in-loop filtering is applied between the block boundary and the block inside, a size of a block to which the selective in-loop filtering is applied, and a flag indicating whether to use an in-loop filter generated for a current frame or an in-loop filter generated for a previous frame.

According to an aspect of another exemplary embodiment, there is provided an in-loop filtering apparatus for eliminating an error of deblocking-filtered image data in a decoder that decodes image data, the in-loop filtering apparatus including: an in-loop filter information receiver which receives in-filter information in a signal decoded by the decoder; and an in-loop filter applier which performs, according to the received in-loop filter information, selective filtering on at least one of a block boundary and a block inside of the deblocking-filtered image based on a first in-loop filter using a first filter coefficient for the block boundary of the deblocking-filtered image and a second in-loop filter using a second filter coefficient for the block inside of the deblocking-filtered image.

According to an aspect of another exemplary embodiment, there is provided a video coding apparatus for encoding image data, the video coding apparatus including: an image predictor which generates a predicted image of an original image to be encoded; a difference signal generator which generates a difference signal between the original image and the predicted image; a deblocking filter portion which performs deblocking filtering on a decoded image using the difference signal and the predicted image to eliminate errors; and an in-loop filter portion which performs filtering separately on a block inside and a block boundary of the deblocking-filtered image.

According to an aspect of another exemplary embodiment, there is provided a method of generating in-loop filters for performing in-loop filtering of an image block of a slice of an image, the method including: generating a first in-loop filter using a first filter coefficient for a block boundary of the image block; and generating a second in-loop filter using a second filter coefficient for a block boundary of the image block.

According to an aspect of another exemplary embodiment, there is provided a method of performing an in-loop filtering on an image block of an image, the method including: determining whether the in-loop filtering is applied to a boundary of the image block or an inside of the image block; and selecting an optimum filter according to whether the in-loop filtering is determined to be applied to the boundary or the inside, and performing the in-loop filtering using the selected optimum filter.

### BRIEF DESCRIPTION OF THE DRAWINGS

The above and/or other aspects will be more apparent from the following detailed description taken in conjunction with the accompanying drawings, in which:

FIG. 1 is a block diagram of a video coding apparatus using adaptive in-loop filters based on characteristics of image blocks and context information according to an exemplary embodiment;

FIG. 2 is a block diagram of a video decoding apparatus according to an exemplary embodiment;

FIG. 3 illustrates in-loop filtering inside four 4×4 adjacent image blocks and at a boundary between four 4×4 adjacent image blocks according to an exemplary embodiment;

FIG. 4 is a flowchart illustrating an operation of an in-loop filter portion in a video coding apparatus according to an exemplary embodiment;

FIG. 5 is a flowchart illustrating an operation of an in-loop filter portion in a video decoding apparatus according to an exemplary embodiment;

FIG. 6 illustrates an example of in-loop filtering at a boundary between blocks according to an exemplary embodiment;

FIG. 7 illustrates an example of in-loop filtering inside a block according to an exemplary embodiment; and

FIG. 8 illustrates an example of transmitting in-loop filter information according to an exemplary embodiment.

### DETAILED DESCRIPTION OF EXEMPLARY EMBODIMENTS

The matters defined in the description such as a detailed construction and elements are provided to assist in a comprehensive understanding of exemplary embodiments. Accordingly, those of ordinary skill in the art will recognize that various changes and modifications of the exemplary embodiments described herein can be made without departing from the scope and spirit of the present inventive concept. Also, descriptions of well-known functions and constructions are omitted for clarity and conciseness. Throughout the drawings, the same drawing reference numerals will be understood to refer to the same elements, features and structures throughout. Expressions such as “at least one of,” when preceding a list of elements, modify the entire list of elements and do not modify the individual elements of the list.

Exemplary embodiments relate to in-loop filters of video compression technologies. Coding errors are eliminated by generating different adaptive in-loop filters which minimize errors between a reconstructed image and an original image and applying the adaptive in-loop filters to an inside and a boundary of an image block. Therefore, more accurate prediction is possible during motion estimation and compensation, thereby increasing coding efficiency.

Exemplary embodiments as described below increase coding efficiency by generating an in-loop filter that minimizes errors between an original image and an image reconstructed by encoding the original image, for each slice, and applying the in-loop filters to the reconstructed image. Specifically, even within the same slice, a different in-loop filter coefficient is determined according to an image block, and the size of an in-loop filter may be different from that of an image block. An in-loop filter coefficient applied to an image block, information indicating whether in-loop filtering is to be performed in the image block, and an in-loop filter size may be transmitted to a video decoding apparatus. In addition, information about image blocks of the same size as an image block to which in-loop filtering is applied may be separately transmitted to the video decoding apparatus. Hence, a video coding apparatus and the video decoding apparatus perform in-loop filtering. Herein, an in-loop filter coefficient, an in-loop filter size, information indicating whether to perform in-loop filtering in an image block, and image block information are referred to as in-loop filtering information.

A video decoding apparatus according to one or more exemplary embodiments obtains an original image by compensating a predicted image of a difference signal produced by dequantization and inverse cosine transform, applies a deblocking filter to the original image, and applies in-loop filters to the inside and boundary of an image block according to received filter information. Thus, information about in-loop filters is separately encoded and transmitted according to one or more exemplary embodiments.

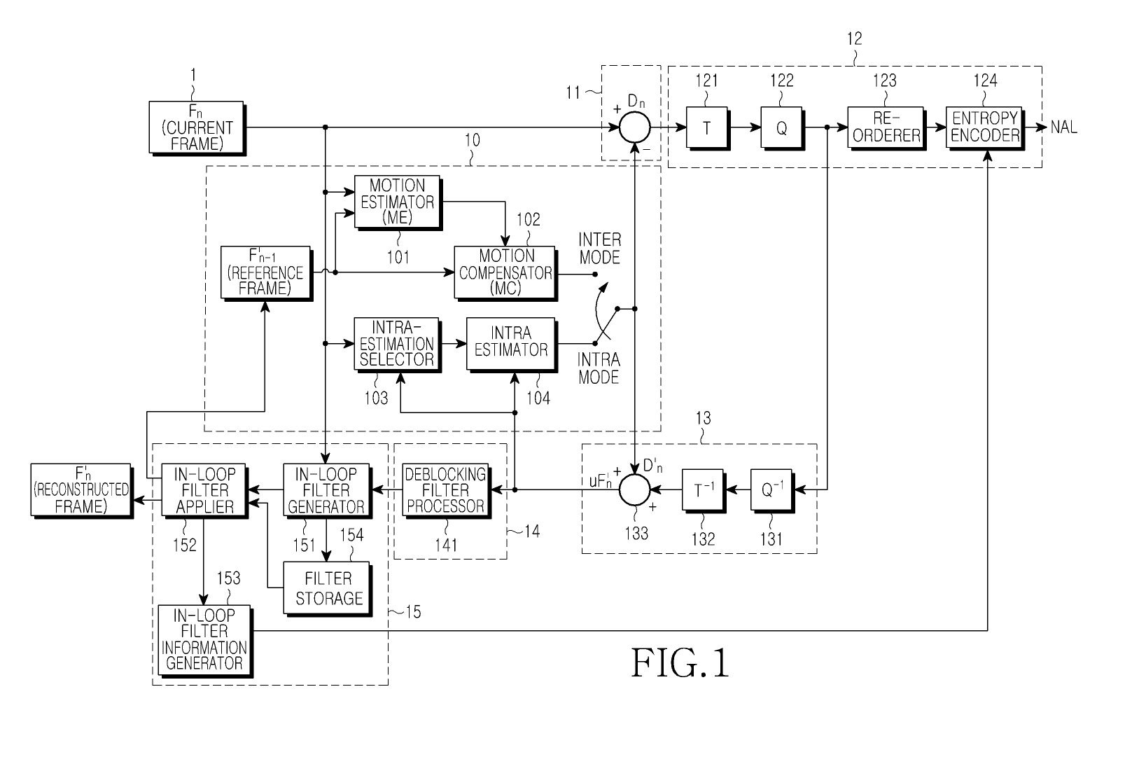

FIG. 1 is a block diagram of a video coding apparatus using adaptive in-loop filters based on characteristics of image blocks and context information according to an exemplary embodiment. Referring to FIG. 1, the video coding apparatus includes an image predictor 10, a difference signal generator 11 which generates a difference signal, an encoder 12, a decoder 13, a deblocking filter portion 14, and an in-loop filter portion 15.

The image predictor 10 includes a motion estimator 101, a motion compensator 102, an intra-estimation selector 103, and an intra estimator 104. The image predictor 10 generates a predicted image for a current original image 1 to be encoded. The difference signal generator 11 generates a difference signal by subtracting the predicted image generated by the image predictor 10 from the current original image 1 to be encoded and outputs the difference signal to the encoder 12.

That is, the image predictor 10 performs motion prediction or estimation to encode one block of a predetermined size in the current frame Fₙ 1 to be encoded and the difference signal generator 11 generates a difference signal Dₙ for the current block.

The encoder 12 includes a discrete cosine transformer 121, a quantizer 122, a re-orderer 123, and an entropy encoder 124. An image is encoded by performing discrete cosine transform on the difference signal in the discrete cosine transformer 121, quantizing the discrete cosine transform signal in the quantizer 122, reordering the quantized signal in the re-orderer 123, and performing entropy coding on the reordered signal in the entropy encoder 124. The coded image may be transmitted through a Network Abstract Layer (NAL).

Moreover, the decoder 13 includes a dequantizer 131, an inverse discrete cosine transformer 132, and an adder 133. The decoder 13 reconstructs an image by compensating an original block during encoding of the current block or frame in order to encode the next block or frame.

More specifically, the decoder 13 reconstructs the original magnitude of the difference signal by dequantizing the magnitude of the discrete cosine transformed and quantized difference signal of the encoder 12 (i.e., the output of the dequantizer 122) in the dequantizer 131 and performing inverse discrete cosine transform on the dequantized signal in the inverse discrete cosine transformer 132. The decoder 13 reconstructs the original image by adding the predicted image output from the image predictor 10 to the reconstructed difference signal (differential image) Dₙ′ and outputs the reconstructed image to the deblocking filter portion 14.

The deblocking filter portion 14 includes a deblocking filter processor 141. The deblocking filter portion 14 improves subjective and objective video qualities by minimizing coding errors at a boundary between image blocks in the reconstructed image generated by the decoder 13.

The in-loop filter portion 15 includes an in-loop filter generator 151, an in-loop filter applier 152, an in-loop filter information transmitter 153, and a filter storage 154. The in-loop filter portion 15 generates different filter coefficients and applies the generated different filter coefficients to an inside and a boundary of an image block in the deblocking filter-applied image received from the deblocking filter portion 141, so as to perform different in-loop filtering on the inside and boundary of the image block. Specifically, the in-loop filter generator 151 generates in-loop filters having different filter coefficients for a boundary image block and an inner image block of a deblocking filtered image.

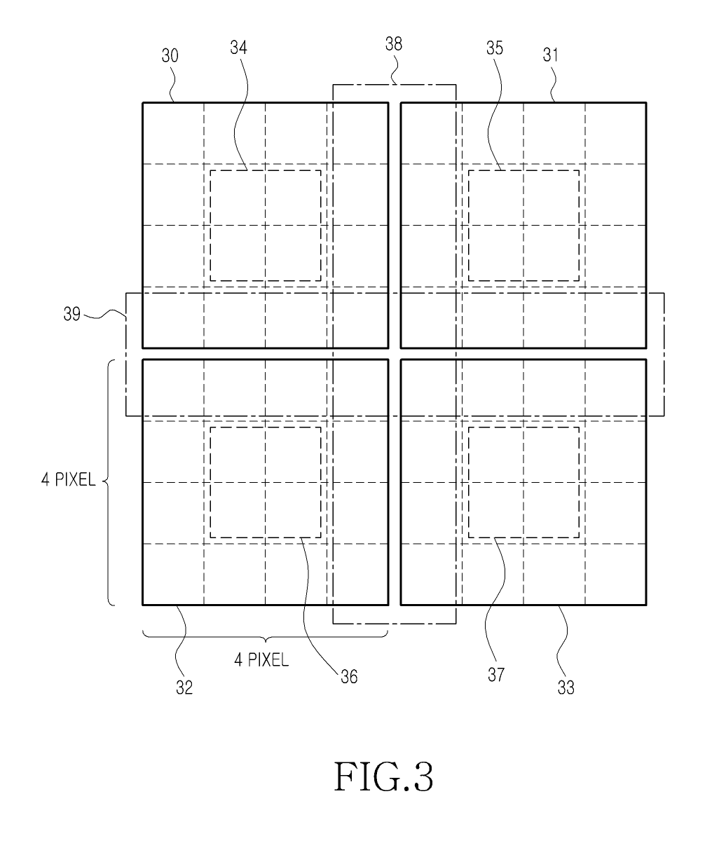

A description of in-loop filtering inside and at a boundary of an image block among four 4×4 adjacent image blocks according to an exemplary embodiment will now be provided with reference to FIG. 3.

For example, as illustrated in FIG. 3, filters having different characteristics can be generated for the insides and boundaries of four 4×4 adjacent image blocks 30, 31, 32 and 33. The in-loop filtering areas of an image may be defined as an inner block area 34, 35, 36 or 37 and as a boundary block area 38 or 39. An image block experiences weaker block distortion inside than at a boundary. Hence, a filter with a smaller filtering strength may be applied to the inside of the image block. In contrast, because the boundary of the image block undergoes stronger block distortion, a filter with a larger filtering strength may be applied to the boundary of the image block. The in-loop filters for the inside and boundary of an image block may have the same or different sizes. It is understood that a size of the image block to which a filter is applied is not limited to 4×4 and various sizes are available for the image block according to various exemplary embodiments. Hence, an image may be divided on a Quadtree basis. An image block may be referred to in various manners. For example, an image block may be referred to as a coding unit, a prediction unit, or a transform unit. In accordance with an exemplary embodiment, the in-loop filter generator 151 generates an in-loop filter coefficient in a manner that, for example, reduces a Mean Square Error (MSE) by comparing the current frame Fₙ 1 of the original image with the deblocking-filtered image from the deblocking filter portion 141. As an example, the in-loop filter coefficient may be generated by a Wiener Filter technology.

The in-loop filter applier 152 selects an optimum filter coefficient between the filter coefficient of the current frame generated by the in-loop filter generator 151 and a filter coefficient of a previous frame stored in the filter storage 154. To select the optimum filter coefficient, the in-loop filter applier 152 may take into account an error calculated using MSE for the previous and current frames and a cost caused by the overhead of transmitting the filter coefficient to be applied to the current frame.

When the new in-loop filter is determined to be optimum, the in-loop filter applier 152 updates the filter coefficient stored in the filter storage 154 to the new in-loop filter coefficient. On the other hand, if the previous filter coefficient stored in the filter storage 154 is determined to be optimum, the in-loop filter applier 152 performs in-loop filtering using the stored previous filter coefficient.

The in-loop filter information generator 153 generates information, such as a flag, indicating whether the in-loop filter applier 152 has performed in-loop filtering using the current filter coefficient generated from the in-loop filter generator 151 or the filter coefficient of the previous frame stored in the filter storage 154. For example, if the flag is “1,” the filter coefficient generated for the current frame by the in-loop filter generator 151 is to be used. If the flag is “0,” the filter coefficient of the previous frame 151 is to be used for in-loop filtering. In the case where a plurality of previous filter coefficients are stored in the filter storage 154, the in-loop filter information generator 153 may generate an index indicating a filter coefficient selected as optimum from among the plurality of filter coefficients and may transmit the index information in in-loop filter information.

The in-loop filter applier 152 filters an image by applying different filters to the inside and boundary of an image block based on the optimum in-filter selected between the in-loop filter generated from the in-loop filter generator 151 and the in-loop filter stored in the filter storage 154.

Information about the filters applied to the inside and boundary of the image by the in-loop filter applier 152 is encoded in the encoder 12 through the in-loop filter information generator 153 and transmitted to the video decoding apparatus.

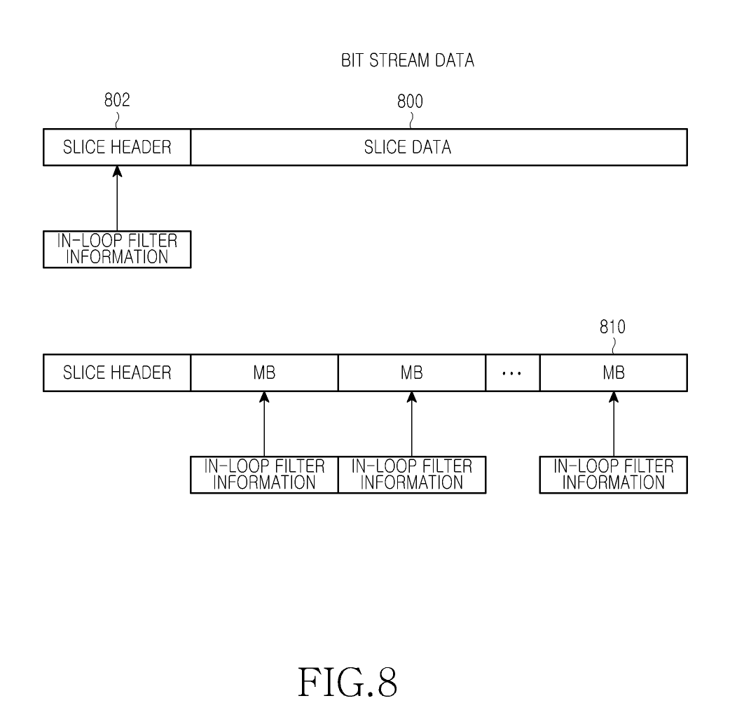

In the present exemplary embodiment, the in-loop filter information includes a filter coefficient applied to a block boundary or a block inside, information indicating whether an in-loop filter is to be applied to the block boundary or the block inside, area size information indicating a size of a boundary block area or an inner block area to which the in-loop filter is to be applied, and a flag indicating whether an in-loop filter coefficient applied to a previous frame is still used. Specifically, the in-loop filter information may be transmitted on a slice basis as indicated by reference numeral 800 or on a macro block basis as indicated by reference numeral 810 in FIG. 8. In the former case, the in-loop filter information may be carried in a slice header 802, whereas in the latter case, the in-loop filter information may be delivered in a macro block 810.

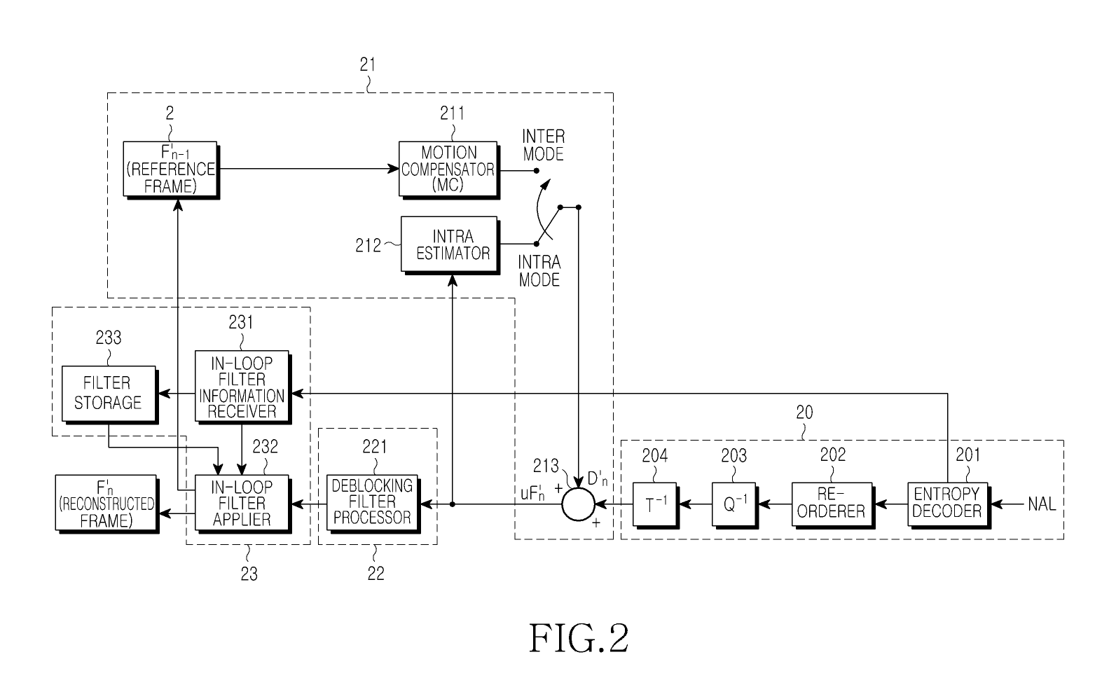

FIG. 2 is a block diagram of a video decoding apparatus according to an exemplary embodiment. Referring to FIG. 2, the video decoding apparatus includes a decoder 20, an image reconstructor 21, a deblocking filter portion 22, and an in-loop filter portion 23.

The decoder 20 includes an entropy decoder 201, a re-orderer 202, a dequantizer 203, and an inverse discrete cosine transformer 204. The decoder 20 entropy-decodes a bit stream received from a video coding apparatus (such as the apparatus illustrated in FIG. 1) in the entropy decoder 201, re-orders the entropy-decoded signal in the re-orderer 202, dequantizes the reordered data in the dequantizer 203, and performs inverse discrete cosine transform on the dequantized data in the inverse discrete cosine transformer 204.

The image reconstructor 21 includes a motion compensator 211, an intra estimator 212, and an adder 213. The image reconstructor 21 reconstructs an original image using a decoded difference signal Dₙ′ and a reference image F′n−1 2 (e.g., a previous image) decoded in the decoder 20 and outputs the reconstructed image to the deblocking filter portion 22.

The deblocking filter portion 22 includes a deblocking filter processor 221 and improves subjective and objective video qualities by eliminating coding errors at the boundary between image blocks in the reconstructed image.

The in-loop filter portion 23 includes an in-filter information receiver 231 and an in-loop filter applier 232. To be more specific, the in-loop filter information receiver 231 receives in-loop filter information decoded by the decoder 20. According to an exemplary embodiment, the in-loop filter information includes a filter coefficient applied to a block boundary or a block inside, information indicating whether an in-loop filter is to be applied to the block boundary or the block inside, area size information indicating the size of a boundary block area or an inner block area to which the in-loop filter is to be applied, and a flag indicating whether an in-loop filter coefficient applied to a previous frame is still used.

The in-loop filter information receiver 231 determines whether to update an in-loop filter coefficient or to use a previous in-loop filter coefficient by checking the flag included in the received in-loop filter information. If the flag indicates updating of the in-loop filter coefficient (e.g., if the flag is “1”), the in-loop filter information receiver 231 updates an existing filter coefficient with the filter coefficient included in the in-loop filter information in the filter storage 233. On the other hand (e.g., if the flag is “0”), the in-loop filter information receiver 231 notifies the in-loop filter applier 232 that in-loop filtering is to be performed using the in-loop filter coefficient of a previous frame stored in the filter storage 233.

When a previous in-loop filter coefficient is not stored in the filter storage 233, the in-loop filter information receiver 132 stores the received filter coefficient in the filter storage 233.

If the flag is “0” and a plurality of previous filter coefficients are stored in the filter storage 233, the in-loop filter information receiver 132 may receive index information indicating an optimum filter coefficient selected from among the filter coefficients stored in the filter storage 233. When the in-loop filter information receiver 132 receives the index information, the in-loop filter applier 132 may perform in-loop filtering on a deblocking-filtered image using the filter coefficient indicated by the index information among the filter coefficients stored in the filter storage 233.

If the flag is “1,” the in-loop filter applier 232 performs in-loop filtering on the inside and the boundary of the deblocking-filtered image block using filters to which in-loop filter coefficients included in the received in-loop filter information are applied. If the flag is “0,” the in-loop filter applier 232 performs in-loop filtering using previous filter coefficients stored in the filter storage 233.

For example, filter coefficients having different characteristics may be applied to the inside of an image block 34, 35, 36 or 37 and the boundary of the image block 38 or 39. As described above, an image block experiences weaker block distortion inside than at a boundary. Hence, a filter with a smaller filtering strength may be applied to the inside of the image block. In contrast, because the boundary of the image block undergoes stronger block distortion, a filter with a larger filtering strength may be applied to the boundary of the image block. The filters for the inside and the boundary of an image block may have the same or different sizes. It is understood that the size of the image block to which a filter is applied is not limited to 4×4 as illustrated in FIG. 3, and various sizes are available for the image block according to various exemplary embodiments.

According to the present exemplary embodiment, the in-loop filter applier 232 may determine an area to which an in-loop filter is to be applied between the inside of an image block and the boundary of the image block, based on the information indicating whether an in-loop filter is applied. If determining to apply in-loop filters to the inside and the boundary of the block, the in-loop filter applier 232 performs in-loop filtering on the block inside and the block boundary corresponding to the area size to which in-loop filtering is applied, indicated by the area size information, using the received filter coefficients. If the in-loop filter application information indicates in-loop filtering only for one of the block inside and the block boundary, the in-loop filter applier 232 performs in-loop filtering on the indicated block area. If the in-loop filter application information indicates no in-loop filtering, the in-loop filter applier 232 does not perform in-loop filtering on the image block.

In the present exemplary embodiment, the in-loop filter information receiver 231 may receive the in-loop filter information on a slice basis as indicated by reference numeral 800 or on a macro block basis as indicated by reference numeral 810 in FIG. 8.

Furthermore, the in-loop filters according to the present exemplary embodiment may be extended to spatial extended coding, quality extended coding, and temporal extended coding of scalable video coding (SVC) in the above-described manner.

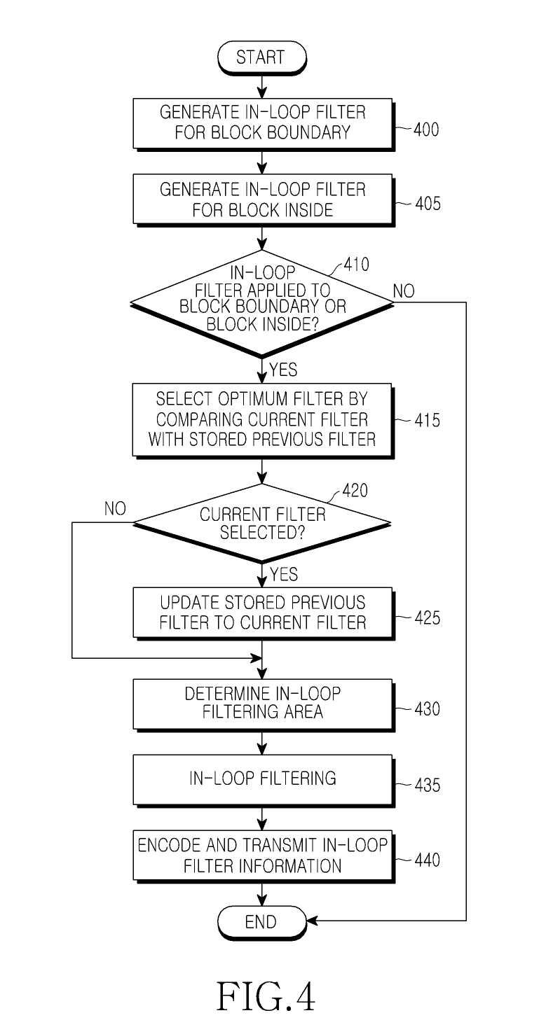

FIG. 4 is a flowchart illustrating an operation of an in-loop filter portion in a video coding apparatus according to an exemplary embodiment. Referring to FIG. 4, the in-loop filter portion generates an in-loop filter to be applied to a block boundary in step 400 and generates an in-loop filter to be applied to a block inside in step 405. More specifically, the in-loop filter portion generates filter coefficients for filters that will perform in-loop filtering on the inside and the boundary of a block in steps 400 and 405, respectively. Herein, the terms “filter coefficient” and “filter” are interchangeable.

In step 410, the in-loop filter portion determines whether to perform in-loop filtering on the block boundary or the block inside using an in-loop filter in step 410. If determining to perform the in-loop filtering, the in-loop filter portion selects an optimum filter by comparing a current generated filter with a previously stored filter in step 415. In step 420, the in-loop filter portion determines whether the selected filter is the current generated filter. In the case that the current generated filter is selected, the in-loop filter portion updates the previously stored filter to the current generated filter in step 425 and determines an in-loop filtering area in step 430.

Meanwhile, if the filter selected in step 420 is not the current generated filter, i.e., the previously generated filter is selected, the in-loop filter portion jumps to step 430 and determines an in-loop filtering area in step 430.

In step 435, the in-loop filter portion performs in-loop filtering on the determined in-loop filtering area using the selected in-loop filter. Then, the in-loop filter portion encodes and transmits in-loop filter information in step 440. In the presence of a plurality of previously stored filters in step 415, index information indicating an optimum filter selected from among the plurality of previously stored filters is generated. The index information is encoded as in-loop filter information and transmitted in step 440.

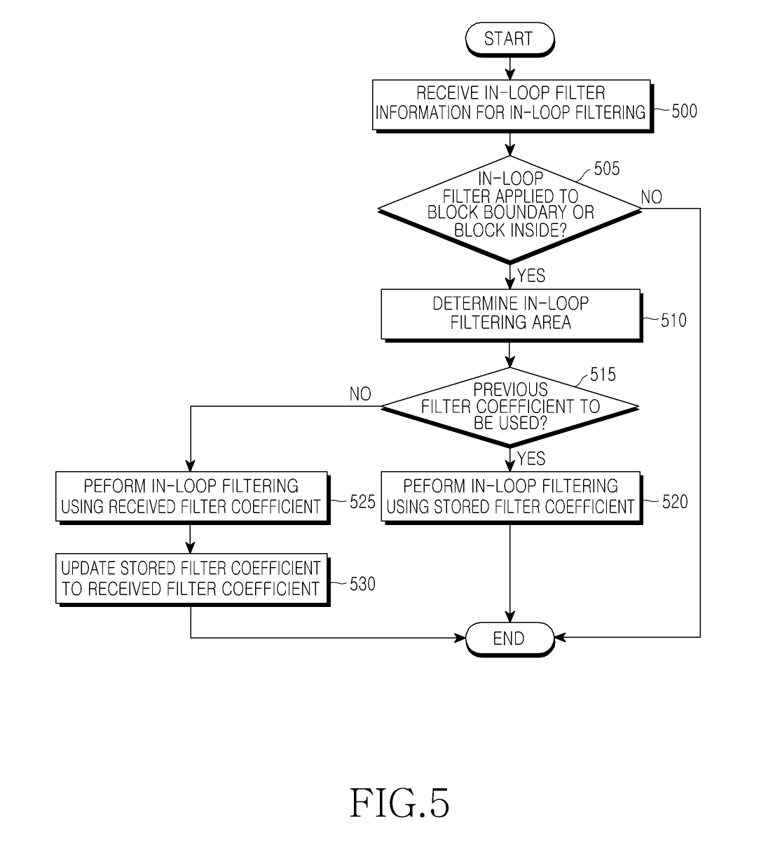

FIG. 5 is a flowchart illustrating an operation of an in-loop filter portion in a video decoding apparatus according to an exemplary embodiment. Referring to FIG. 5, the in-loop filter portion receives in-loop filter information for in-loop filtering in step 500 and determines whether to apply an in-loop filter to a block boundary or a block inside based on in-loop filter application information included in the in-loop filter information in step 505. If determining to apply an in-loop filter, the in-loop filter portion determines an in-loop filtering area in step 510.

In step 515, the in-loop filter portion determines whether to use a previous in-loop filter coefficient by checking information (e.g., a flag) included in the received in-loop filter information.

If a previous filter coefficient is to be used, the in-loop filter portion performs in-loop filtering using a previously stored filter coefficient in step 520. If a previous filter coefficient is to be used and there are a plurality of previously stored filter coefficients in step 515, the in-loop filter portion may perform in-loop filtering using an optimum filter coefficient indicated by index information in step 520.

On the other hand, if it is determined that a previous filter coefficient is not to be used in step 515, i.e., in-loop filtering is to be performed using a current received in-loop filter, the in-loop filter portion performs in-loop filtering using a filter coefficient included in the in-loop filter information in step 525 and updates the previously stored in-loop filter coefficient to the received in-loop filter coefficient in step 530.

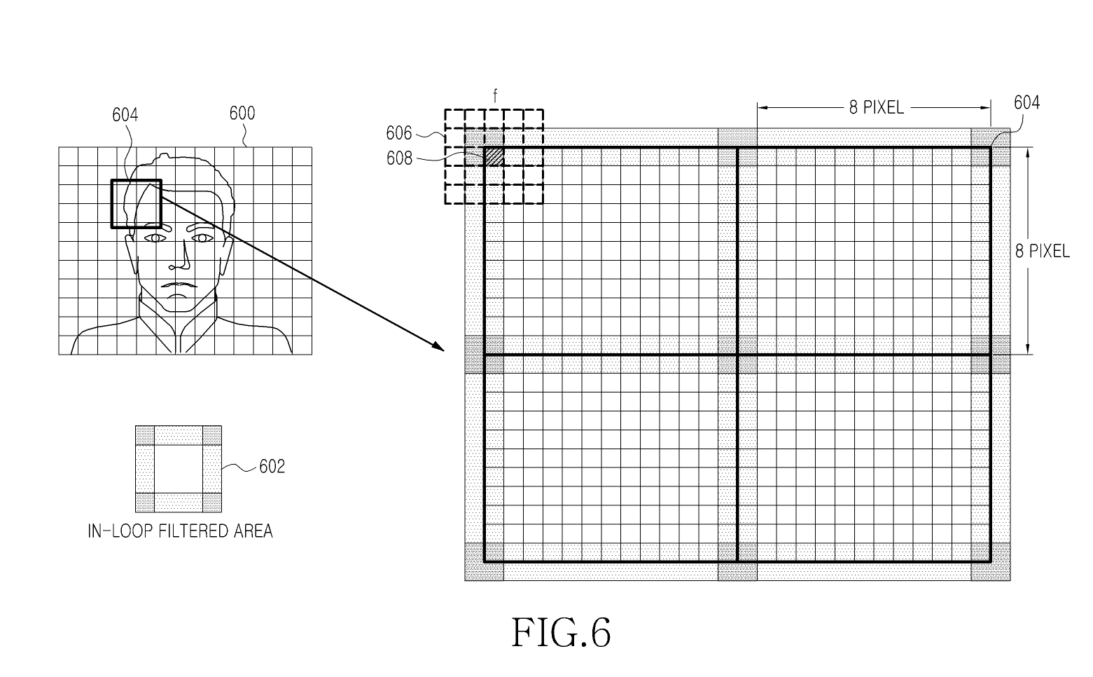

FIG. 6 illustrates an example of in-loop filtering at a boundary between blocks according to an exemplary embodiment. In FIG. 6, reference numeral 600 denotes a reconstructed current frame, reference numeral 604 denotes a 16×16 macro block, and reference numeral 602 denotes an in-loop filtered area in the macro block 604. In-loop filtering of a boundary of the block 604 is illustrated in detail in FIG. 6. The 16×16 macro block is further divided into 8×8 image blocks.

Reference numeral 606 denotes a two-dimensional 5×5 filter for in-loop filtering according to an exemplary embodiment. Reference numeral 608 denotes a center point of the two-dimensional filter 606. The center point 608 of the filter 606 is shown to be at the boundary of the macro block 604 in FIG. 6. In this case, filtering is performed using an in-loop filter coefficient corresponding to a block boundary.

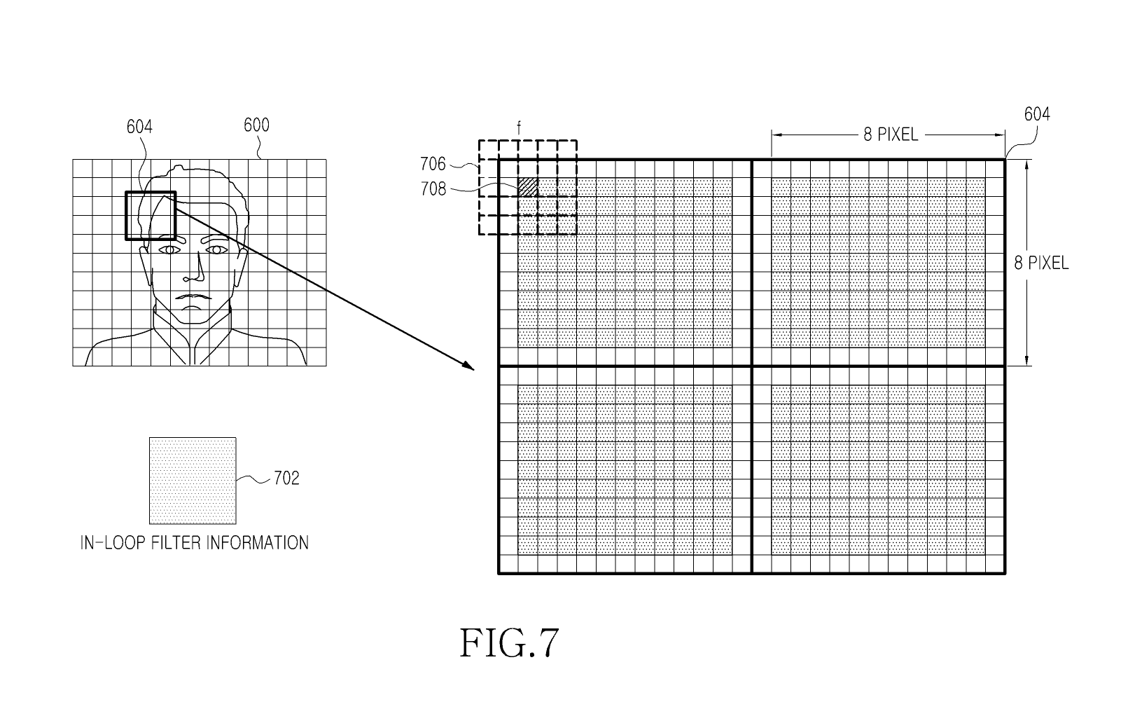

FIG. 7 illustrates an example of in-loop filtering inside a block according to an exemplary embodiment. In FIG. 7, in-loop filtering of a block inside of a 16×16 macro block of the reconstructed current frame 600 is illustrated in detail. Reference numeral 702 denotes an in-loop filtering area inside a block in the 16×16 macro block 604, and reference numeral 706 denotes a two-dimensional 5×5 filter for in-loop filtering according to an exemplary embodiment. Reference numeral 708 denotes the center point of the two-dimensional filter 706. The center point 708 of the filter 706 is shown to be inside the macro block 604 in FIG. 7. In this case, filtering is performed using an in-loop filter coefficient corresponding to a block inside.

While the filters are illustrated as squares in FIGS. 6 and 7, it is understood that other shapes such as a diamond, an oval, a triangle, and a circle may also be used in other exemplary embodiments.

Table 1 illustrates effects that can be achieved when different in-loop filtering is applied to an inside and a boundary of an image block according to an exemplary embodiment:

TABLE 1

| Sequence | size | QP | reference | | proposed | | BDPSNR | BDBitrate |
|---|---|---|---|---|---|---|---|---|
| City_corr | 720P | 22 | 12734438 | 39.921 | 11758639 | 40.292 | 0.809832 | −23.3388 |
| | | 27 | 3111723 | 35.998 | 2704911 | 36.312 | | |
| | | 32 | 1016674 | 32.573 | 855101 | 33.048 | | |
| | | 37 | 470122 | 29.394 | 422758 | 30.153 | | |
| BigShips | 720P | 22 | 6986230 | 39.869 | 6814788 | 39.983 | 0.350833 | −11.6892 |
| | | 27 | 2106329 | 36.429 | 1987961 | 36.555 | | |
| | | 32 | 710304 | 33.399 | 646411 | 33.631 | | |
| | | 37 | 297211 | 30.808 | 285278 | 31.149 | | |
| Crew | 720P | 22 | 6457030 | 41.548 | 6131950 | 41.74 | 0.463787 | −16.7118 |
| | | 27 | 2060573 | 39.058 | 1913086 | 39.304 | | |
| | | 32 | 854875 | 36.712 | 795036 | 37.067 | | |
| | | 37 | 395431 | 34.289 | 281211 | 34.809 | | |
| Night | 720P | 22 | 14210810 | 41.161 | 13853244 | 41.462 | 0.307704 | −7.91954 |
| | | 27 | 5171110 | 37.502 | 5025051 | 37.715 | | |
| | | 32 | 2067266 | 34.201 | 2034223 | 34.421 | | |
| | | 37 | 945089 | 31.123 | 941633 | 31.357 | | |
| | | | | | | | | −59.659 |
| | | | | | | | average | −14.9149 |

Table 1 lists results of a test of an H.264 JM image of 720p resolution under the conditions of 100 frames, high profile, Context-Adaptive Binary Arithmetic Coding (CABC) on, and IPPP as a Group Of Picture (GOP) structure. Referring to Table 1, “QP” represents Quantization Parameter, “reference” denotes related art bit rates and Peak Signal to Noise Ratio (PSNR) values, and “proposed” denotes bit rates and PSNR values of the present invention.

In the results of comparing reference with proposed, where Bjonteggard PSNR (BDPSNR) and Bjonteggard Delta Bitrate (BDBitrate) as objective indicators of coding performance, a positive sign (+) of BDPSNR and a negative sign (−) of BDBitrate indicate improvement in coding performance.

As is apparent from the above description, the exemplary embodiments enable more accurate estimation in motion prediction and compensation, thereby increasing coding efficiency. Also, application of the in-loop filters to spatial extended coding, quality extended coding, and temporal extended coding of SVC increases coding efficiency.

While not restricted thereto, exemplary embodiments can also be embodied as computer-readable codes on a computer-readable recording medium. The computer-readable recording medium is any data storage device that can store data which can thereafter be read by a computer system. Examples of the computer-readable recording medium include, but are not limited to, read-only memory (ROM), random-access memory (RAM), CD-ROMs, magnetic tapes, floppy disks, and optical data storage devices. The computer-readable recording medium can also be distributed over network-coupled computer systems so that the computer-readable code is stored and executed in a distributed fashion. Also, function programs, codes, and code segments for accomplishing the exemplary embodiments can be easily construed as within the scope of the exemplary embodiments by programmers skilled in the art to which the present exemplary embodiments pertain. Also, exemplary embodiments may be written as computer programs transmitted over a computer-readable transmission medium, such as a carrier wave, and received and implemented in general-use or special-purpose digital computers that execute the programs. Moreover, while not required in all aspects, one or more units of the video coding apparatus and the video decoding apparatus can include a processor or microprocessor executing a computer program stored in a computer-readable medium.

While exemplary embodiments have been shown and described, it will be understood by those skilled in the art that various changes in form and details may be made therein without departing from the spirit and scope of the present inventive concept as defined by the appended claims and their equivalents.

What is claimed is:

1. An in-loop filtering apparatus for eliminating an error of deblocking-filtered image data in an encoder that encodes image data, the in-loop filtering apparatus comprising:
an in-loop filter generator which generates, for use in in-loop filtering, a first in-loop filter using a first filter coefficient for a block boundary of the deblocking-filtered image and a second in-loop filter using a second filter coefficient for a block inside of the deblocking-filtered image;
an in-loop filter applier which performs selective filtering on at least one of the block boundary of the image using the generated first in-loop filter and the block inside of the image using the generated second in-loop filter; and
an in-loop filter information generator which generates in-loop filter information comprising at least one of the first and second coefficients of the generated first and second in-loop filters, information indicating an area to which the selective in-loop filtering is applied between the block boundary and the block inside, a size of a block to which the selective in-loop filtering is applied, and a flag indicating whether to use an in-loop filter generated for a current frame or an in-loop filter generated for a previous frame.

2. The in-loop filtering apparatus of claim 1, wherein the first in-loop filter of the block boundary is different from the second in-loop filter of the block inside.

3. The in-loop filtering apparatus of claim 1, wherein a block size of the deblocking-filtered image is variable and a width of the block boundary of the deblocking-filtered image is variable.

4. The in-loop filtering apparatus of claim 1, wherein the first and second in-loop filters are one-dimensional or two-dimensional filters.

5. The in-loop filtering apparatus of claim 1, wherein the first and second in-loop filters are two-dimensional filters and a shape of the first and second in-loop filters is one of a square, a diamond, and a triangle.

6. The in-loop filtering apparatus of claim 1, wherein if a plurality of filter coefficients are previously generated for previous frames, the in-loop filter information includes index information indicating an optimum coefficient among the plurality of filter coefficients for the previous frames.

7. The in-loop filter apparatus of claim 1, wherein the in-loop filter applier performs the selective filtering by using an optimum filter coefficient selected between the at least one of the first and second filter coefficients or a stored filter coefficient of the previous frame.

8. The in-loop filter apparatus of claim 7, wherein the in-loop filter applier selects the optimum filter coefficient according to at least one of a cost caused by an overhead of transmitting the selected optimum filter coefficient and an error calculated using a Mean Square Error (MSE) between an original frame of the image and the deblocking-filtered image.

9. An in-loop filtering apparatus for eliminating an error of deblocking-filtered image data in a decoder that decodes image data, the in-loop filtering apparatus comprising:
an in-loop filter information receiver which receives in-filter information in a signal decoded by the decoder; and
an in-loop filter applier which performs, according to the received in-loop filter information, selective filtering on at least one of a block boundary and a block inside of the deblocking-filtered image based on a first in-loop filter using a first filter coefficient for the block boundary of the deblocking-filtered image and a second in-loop filter using a second filter coefficient for the block inside of the deblocking-filtered image.

10. The in-loop filtering apparatus of claim 9, wherein the first filter coefficient of the block boundary is different from the second filter coefficient of the block inside.

11. The in-loop filtering apparatus of claim 9, wherein a block size of the deblocking-filtered image is variable and a width of the block boundary of the deblocking-filtered image is variable.

12. The in-loop filtering apparatus of claim 9, wherein the first and second in-loop filters are one-dimensional or two-dimensional filters.

13. The in-loop filtering apparatus of claim 9, wherein the first and second in-loop filters are two-dimensional filters and a shape of the first and second in-loop filters is one of a square, a diamond, and a triangle.

14. The in-loop filter apparatus of claim 9, wherein the in-loop filter applier performs the selective filtering by using an optimum filter coefficient selected between the at least one of the first and second filter coefficients or a stored filter coefficient of a previous frame, according to the received in-filter information.

15. A video coding apparatus for encoding image data, the video coding apparatus comprising:
an image predictor which generates a predicted image of an original image to be encoded;
a difference signal generator which generates a difference signal according to a difference between the original image and the predicted image;
a deblocking filter portion which performs deblocking filtering on a decoded image using the difference signal and the predicted image to eliminate errors; and
an in-loop filter portion which performs filtering separately on a block inside and a block boundary of the deblocking-filtered image.

16. The video coding apparatus of claim 15, wherein the in-loop filter portion sets different coefficients for a first in-loop filter to be applied to the block boundary of the deblocking-filtered image and a second in-loop filter to be applied to the block inside of the deblocking-filtered image.

17. The video coding apparatus of claim 15, wherein a block size of the deblocking-filtered image is variable and a width of the block boundary of the deblocking-filtered image is variable.

18. The video coding apparatus of claim 16, wherein the first and second in-loop filters are one-dimensional or two-dimensional filters.

19. The video coding apparatus of claim 16, wherein the first and second in-loop filters are two-dimensional filters and a shape of the first and second in-loop filters is one of a square, a diamond, and a triangle.

20. A method of generating in-loop filters for performing in-loop filtering of an image block of a slice of an image, the method comprising:
generating a first in-loop filter using a first filter coefficient for a block boundary of the image block; and
generating a second in-loop filter using a second filter coefficient for a block inside of the image block.

21. A computer readable recording medium having recorded thereon a program executable by a computer for performing the method of claim 20.

22. A method of performing an in-loop filtering on an image block of an image, the method comprising:
determining whether the in-loop filtering is applied to a boundary of the image block or an inside of the image block; and
selecting an optimum filter according to whether the in-loop filtering is determined to be applied to the boundary or the inside, and performing the in-loop filtering using the selected optimum filter.

23. The method of claim 22, wherein the selecting the optimum filter comprises:
selecting a first in-loop filter when the in-looping filtering is determined to be applied to the boundary, and selecting a second in-loop filter when the in-looping filtering is determined to be applied to the inside;
selecting the optimum filter from among the selected in-loop filter and a stored previous filter.

24. A computer readable recording medium having recorded thereon a program executable by a computer for performing the method of claim 22.
